(19) United States
(12) Patent Application Publication
(10) Pub. No.: US 2003/0084987 A1
(43) Pub. Date: May 8, 2003

(54) Adhesive applicator

(76) Inventors: Peter A. Rodriguez, Jacksonville, FL (US); Thomas B. Middlebrooks, Jacksonville Beach, FL (US)

Correspondence Address: Arthur G. Yeager, P.A., Suite 1305, 112 West Adams Street, Jacksonville, FL, 32202, US

(21) Appl. No.: 10/008,757

(22) Filed: Nov. 8, 2001

(51) Int. Cl. B44C 1/00

(52) U.S. Cl. 156/230; 156/238; 156/542

(57) ABSTRACT

An adhesive applicator for applying a strip of double-sided pressure sensitive adhesive to a surface of a cutting tape, the applicator includes a housing having a rotatable supply roll having layers of spaced strips with exposed face sides and unexposed back sides, each side having a pressure sensitive adhesive thereon, and the back side being adhered to a release liner, a stationary nose member mounted to the housing and having a rounded tip and disposed above the supply roll, a press member or roll positioned above the rounded tip and being movable downwardly to force a lower surface of incoming cutting tape into contact with the exposed face side to cause the exposed face side to adhere to the lower surface and separate from the release liner when the release liner is pulled laterally around the tip, a rotatable nip roll positioned beneath the supply roll for pressing a spent release liner onto the supply roll to keep the spent release liner under tension all the time, and a doctor knife edge adjacent the nip roll and beneath the supply roll for separating the spent release liner from the exposed face sides of the strip while the nip roll presses against the supply roll. In an another embodiment, the adhesive applicator is an integral part of an apparatus for cutting a moving web of paper.

### CROSS REFERENCE TO RELATED APPLICATION

This application is related to an application entitled Roll of Adhesive Labels for Cutting Tape, filed on even date herewith (Attorney Case No. D-7356); and to application entitled Accumulator and Dispensing System for a Cutting Tape, fled on even date herewith, (Attorney Case No. D-7305).

### STATEMENT REGARDING SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to an apparatus for applying a double-sided pressure sensitive adhesive to a surface, and particularly to a paper strip adhesive applied to a cutting tape surface in an apparatus for spooling and cutting a web of paper.

2. Related Art

A few adhesive applicators are known in the art such as those disclosed in Applicant's U.S. Pat. Nos. 5,178,717 and 5,456,792. These applicators are part of an integrated machine for spooling and cutting a traveling web of paper. The first adhesive applicator includes a supply roll having layers of a double-sided tape adhered to a strippable backing, a transfer roll to remove the adhesive tape from the release backing and apply the tape to the surface, and an additional roll winds up the release backing. The second adhesive applicator includes a transfer roll that receives a composite tape of a double-sided pressure sensitive adhesive tape adhered to a backing layer strip wrapped around a supply roll. The tape temporarily adheres to the transfer roll and then after some rotation, applies the tape to a receiving surface. A return bend surface is positioned in proximity to the transfer roll to separate the backing layer from the adhesive tape adhering to the transfer roll. The separated backing layer exits through a channel to a waste zone.

Processing difficulties have arisen regarding the adherence of tape to transfer roll and instance of feeding machine failure to apply a strip of double-sided pressure sensitive adhesive tape properly to a cutting tape. There is a need for improved adhesive applicator to a cutting tape.

It is an object of the present invention to provide for an improved apparatus for applying adhesive to a cutting tape efficiently.

It is a related object to provide a double sided adhesive to a paper label strip to a cutting tape accurately.

It is another object of the present invention to provide a sensing mechanism to determine if the cutting tape exiting the adhesive applicator has adhesive on its surface.

It is a further object of the present invention to provide for an apparatus for applying a double-sided pressure sensitive adhesive paper strip to a surface of a cutting tape in combination with an apparatus for cutting and spooling a traveling web of paper.

It is an additional object of the present invention to provide an adhesive applicator, which is a part of an apparatus for spooling and cutting a web of paper, that includes a mechanism for sensing the presence or absence of adhesive on a surface of the cutting tape after the tape exits the applicator.

Still other objects will become apparent from the more detailed description that follows.

### BRIEF SUMMARY OF TEE INVENTION

The present invention relates to an adhesive applicator for applying a strip of double-sided pressure sensitive adhesive to a surface of a cutting tape traveling through an elongated track. The applicator includes a housing having an upper portion and a lower portion, a rotatable spindle for receiving a supply roll having layers of spaced strips with exposed face sides and unexposed back sides with each side having a pressure sensitive adhesive thereon, and the back side being adhered to a release liner. The spindle is positioned generally medially of the upper portion. The housing has an elongated body and having a truncated portion at the proximal end of the upper portion A stationary nose member is mounted on the truncated portion and having a rounded tip exposed outwardly of the housing and being disposed at a proximal end of the upper portion of the housing above the spindle and any supply roll disposable on the spindle. The applicator also includes a press member, preferably a rotatable press roll, positioned diametrically opposite and above the rounded tip and is vertically movable downwardly to force the lower surface of a generally horizontal incoming cutting tape into contact with the exposed face side of the adhesive strip on the rounded tip to cause the exposed face side to adhere to the lower surface of the cutting tape and separate from the release liner when the release liner rotates around the tip. The applicator further includes a rotatable nip roll spacedly positioned beneath the supply roll for pressing a spent release liner onto the supply roll to aid rotation of the supply roll, and a doctor knife edge positioned spacedly and adjacent the nip roll and beneath the supply roll for separating the spent release liner from the exposed face sides of the strip around the supply roll while the nip roll presses against the supply roll.

The applicator further includes a waste channel formed in a space between the doctor knife edge and the nip roll for receiving the spent release liner and sending it to a waste zone. Beneath the doctor knife edge and the nip roll are means for urging them upwardly to press the spent release liner onto the supply roll to aid rotation of the supply roll and to enable the doctor knife edge to separate the spent release liner from the exposed face sides of the strip around the supply roll as the supply roll is being depleted and its circumference is decreased.

The applicator has an optical sensor positioned outside the housing in proximity with and upstream from the press roll and adjacent the track for detecting movement of an incoming cutting tape and signaling to the press roll to move downwardly to press the lower surface of incoming cutting tape into contact with the exposed face side of the adhesive.

The applicator also includes an optical sensor positioned in proximity with the stationary nose member for detecting presence or absence of adhesive on the surface of the generally horizontally exiting cutting tape, an upwardly movable abort block means positioned adjacent the track, and a control for receiving output signals from the sensors and sending signals to the abort block means to move upwardly to divert a cutting tape for having no adhesive on its lower surface.

In a specific embodiment, the applicator is an integral part of an apparatus for cutting a moving web of paper being wound on a spool and transferring a web onto an

The present invention also relates to a method for applying the paper strip of double-sided pressure sensitive adhesive to the cutting tape surface. The method comprises the steps of rotating layers of spaced strips with exposed face sides and unexposed back sides with each side having a pressure sensitive adhesive thereon, the back side being adhered to a release liner, around a rounded tip of a stationary nose member, downwardly moving a press member to press a lower surface of a generally horizontally incoming cutting tape into contact with the exposed face side of the adhesive strip on a rounded tip into contact to cause adherence to the lower surface of the cutting tape and separation from the release liner when the release liner sufficiently moves around the tip, pushing the cutting tape in a generally horizontal direction to force a substantial portion of a facing side of the strip to adhere to the cutting tape, tensioning the release liner downwardly to separate the strip moving with the cutting tape from the release liner, upwardly moving the press member away from the lower surface of the cutting tape, upwardly moving a nip roll to press the spent release liner onto the supply roll to aid rotation of the supply roll and to position the next strip ready for adherence to the next cutting tape, separating the spent release liner from the exposed face sides of the strips around the supply roll by a doctor knife edge, and upwardly urging the doctor knife edge and the nip roll against the supply roll to assure rotation of the supply roll and to enable the doctor knife edge to separate the spent release liner from the exposed face sides of the strip as the thickness of the strip decreases due to consumption of the strips on the spent release liner, and guiding the spent release liner into a waste zone.

### BRIEF DESCRIPTION OF THE DRAWINGS

The novel features believed to be characteristic of this invention are set forth with particularity in the appended claims. The invention itself, however, both as to its organization and method of operation, together with further objects and advantages thereof, may best be understood by references to the following description taken in connection with the accompanying drawings in which:

FIG. 1 shows a diagrammatic prior art apparatus for spooling and cutting a web of paper;

FIG. 2 is a side diagrammatic view showing an apparatus for spooling and cutting a web of paper having an adhesive applicator in accord with the present invention; and

FIG. 3A is a plan view of the spaced paper strips on the roll employed in the adhesive applicator of this invention;

FIG. 3B is an enlarged cross sectional view taken along lines 3B-3B of FIG. 3A, and

FIG. 4 is a side elevational view showing the adhesive applicator in greater detail according to the present invention.

### DETAILED DESCRIPTION OF THE INVENTION

The present invention may be configured to be employed by itself or as an integrated part of another apparatus.

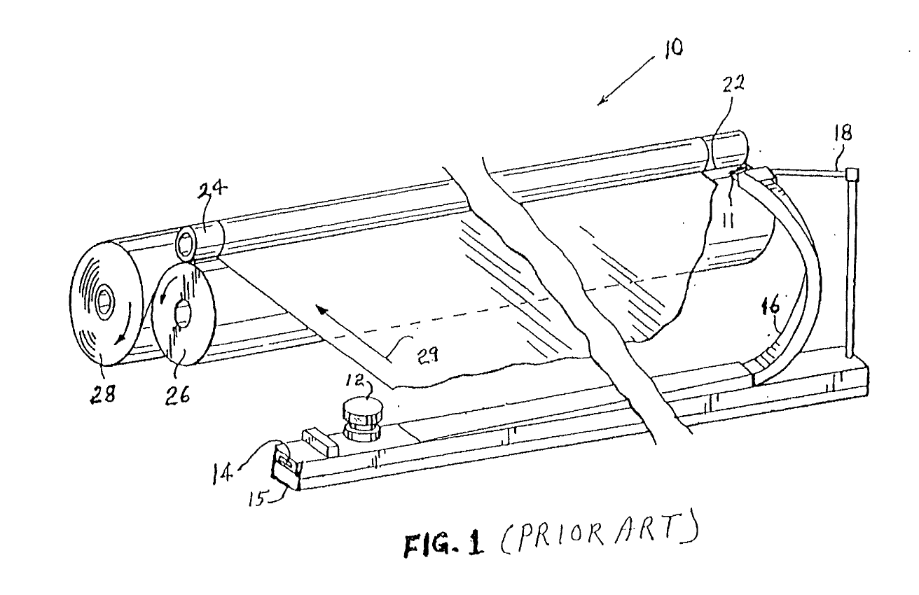

FIG. 1 is a prior art drawing of a specific embodiment wherein the present invention may be an integral part of a prior art apparatus for spooling and cutting a web of paper 10 used in the paper industry to cut a moving web of paper 29 being wound on a spool 28 and to transfer the cut edge of the paper to an empty wind up spool 24 without having to stop the paper web movement, as disclosed in Applicant U.S. Pat. Nos. 5,178,717 and 5,456,792. In order to cut moving paper web 29 and start it winding onto the empty spool 24, a cutting tape 11 is moved forward and is caught in the nip 22 formed between the web driving spool 26 and the empty spool 24. The tape 11 is wrapped helically around the spool 28 and in so doing it cuts through the paper web 29 and leads the cut edge onto the empty spool 24, which continues to wind up the web 29 until it is full and the entire operation is repeated to cut and transfer the web to a new empty wind up spool. Soon after, the web 29 is transferred to the spool 24, the spool 28 is moved away from the drive spool 26 and the new empty spool 24 is moved down to the previous position of the full spool 28.

The tape 11, which is introduced into the track 14, is directed to a dispensing section, not shown, where it is treated to apply a pressure sensitive adhesive to the forward portion of the tape 11. The tape 11 is then cut into a finite length and pushed along until the tape 11 is at the end of the curved section 16. The tape 11 is then stopped until an operator decides it is time to cut and transfer the web 29 to a new spool. The tape 11 is advanced into the nip 22 and brake section 12 is applied as known in the art. A portion of the apparatus 10 is not shown, but includes a main driving wheel for forwarding the cutting tape 11 and an adhesive applicator for applying a strip of double-sided pressure sensitive adhesive to a surface of the cutting tape 11, all located before the brake section 12.

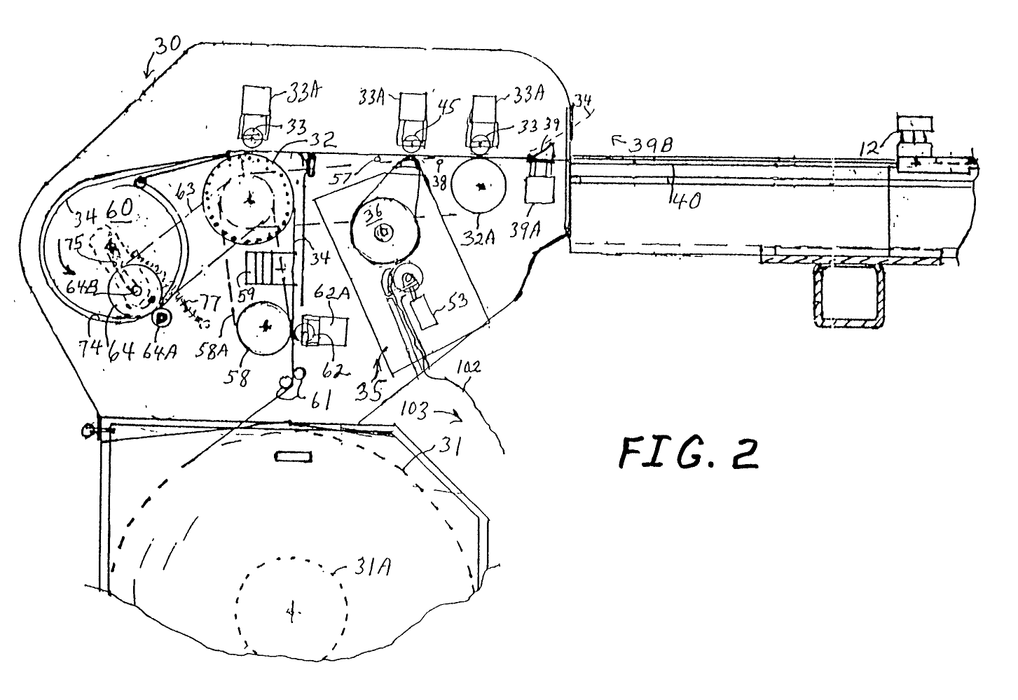

FIG. 2 is a side diagrammatic view showing a portion of an apparatus 30 in accord with this invention for spooling and cutting a web of paper 29 located before the brake section 12 and including the adhesive applicator 35 of the present invention as an integral part of the apparatus 30, as one specific embodiment in accord with the present invention. Generally, the apparatus 30 includes a cutting tape 34 wound around a supply storage roll 31 having layers of the cutting tape 34 wrapped around a spindle 31A to supply cutting tape 34 through a pair of rolls 61 and thence between a first driver roll 58 and press roll 62 movable by actuator 62A to feed cutting tape 34 around main driving roll 32, which drives roll 58 via belt 58A. The first roll 58 advances cutting tape 34 through cutting station 59 and then to rotate around main driving roll 32, which is also coupled by moving belt 63 to an inner roll 64, which is rotating inside storage container 60, to transfer rotative power between them. The main driving roll 32 with the assistance of auxiliary upper roll 33, being selectively movable upwardly and downwardly by a solenoid or air cylinder actuator 33A, advances cutting tape 34 to the inner roll 64 to accumulate a pre-determined single length of cutting tape 34 sufficient to cut one traveling web of paper, shown in FIG. 1. The inner roll 64 presses an upper surface 73 of the cutting tape 34 against a roll 64A protruding partially through a slot in the circumference wall 74 of the accumulator storage container 60 to rotatably accumulate the cutting tape 34 therein. The inner roll 64 moves in variably different speeds and in an inverse proportion to the thickness of the accumulated layers of the cutting tape 34. The inner roll 64 is coupled to a friction clutch mechanism, not shown, that permits variation in the speed of the roll 64. As the layers of the cutting tape 34 accumulate, the roll 64 moves upwardly in an arcuate slot 75 inside the storage container 60 as the diameter of roll 64 with wrapped tape 34 thereon increases the combined diameter to accommodate for the pre-determined single length of the cutting tape 34 so wound. When the cutting tape 34 begins to unwrap as the main driving roll 32 reverses to advance the cutting tape 34 through the guideway in the apparatus 30 to the adhesive applicator 35, the diameter of the accumulated cutting tape begins to decrease allowing the roll 64 to move its shaft 64B downwardly through the slot 75. The roll 64 is also urged downwardly by tensioned spring 77 until it reaches a lower position of the slot 75 with roll 64 juxtaposed to roll 64A ready to receive the next cutting tape 34. The main driving roll 32 controls by its rotation the pre-determined length of the cutting tape 34 required and sends activating control signals to the cutting station 59 to cut the cutting tape 34 at such point. The new cut end of the cutting tape 34 remains at the cutting station 59 to be advanced thereafter to the main driving roll 32 to repeat the process to cut a traveling web of paper 29. While the cut trailing end of the tape 34 is moved by main driving roll 32 until its end is located between main driving roll 32 and upper auxiliary roll 33, and roll 32 is stopped until an operator decides to prepare to cut and transfer a traveling web of paper 29 to a new spool 24 by advancing cutting tape 34 through rearward guideway in the apparatus 30 to the adhesive applicator 35 of the present invention to apply adhesive to cutting tape 34 before advancing through the track 14. After receipt of the adhesive, the cutting tape 34 is then forwarded by roll 32 and 32A pass the brake section 12 therein until an operator decides it is time to cut and transfer a traveling web of paper 29 by releasing cutting tape 34 through the track 40 and curve section guide 16 to be fed to the nip 22 formed between web driving spool 26 and empty spool 24 and to attach the end of tape 34 to spool 24, applying the brake 12 to thence cut moving paper web 29 and start it winding onto empty spool 24, as shown in FIG. 1.

Applicants' contemporaneously filed application entitled An Accumulator and Dispensing System for a Cutting Tape, Attorney Case No. D-7305, is incorporated herein by reference, and such Application fully discloses the specifics of the accumulator storage container 60 and the operation thereof.

The adhesive applicator 35 of the present invention includes an optical sensor 38, which is positioned in proximity with and downstream from the adhesive applicator 35 to detect the presence or absence of adhesive on the cutting tape 34. The optical sensor 38 communicates with a control mechanism actuator 39A and an abort block means 39, which is positioned adjacent to the track 40. If the sensor 38 detects no adhesive on the cutting tape 34 after exiting the adhesive applicator 35, it sends a signal that activates a solenoid or air cylinder actuator 39A to move the abort clock means 39 down onto the track 40 to divert the leading portion of cutting tape or band 34 in the storage container 60 to a waste zone 39 for use by hand application of adhesive. The band may then be retracted by the apparatus back upstream from the abort block means 39 and then the abort block means 39 is moved downwardly so that the band or cutting tape 34 with adhesive may then be moved through the track 40. A similar abort block and actuator is disclosed in U.S. Pat. No. 5,417,383 dated May 23, 1995.

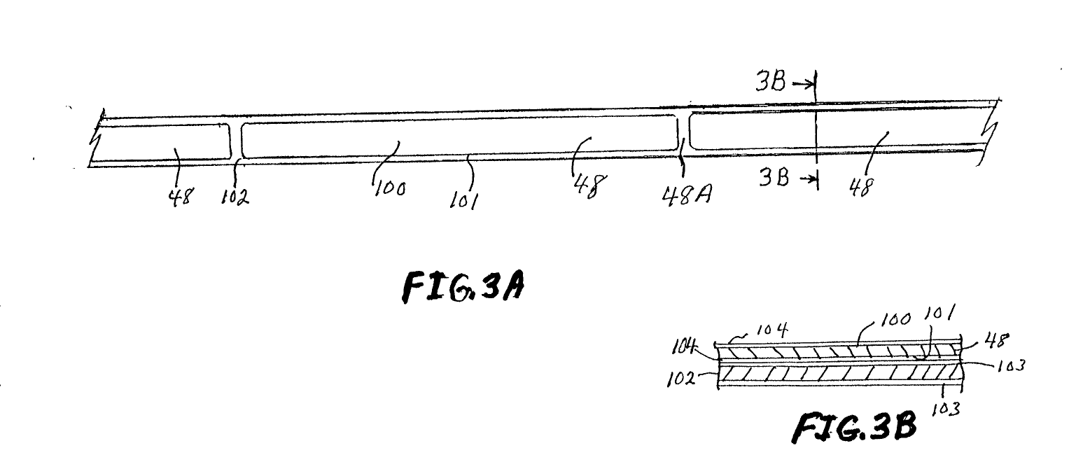

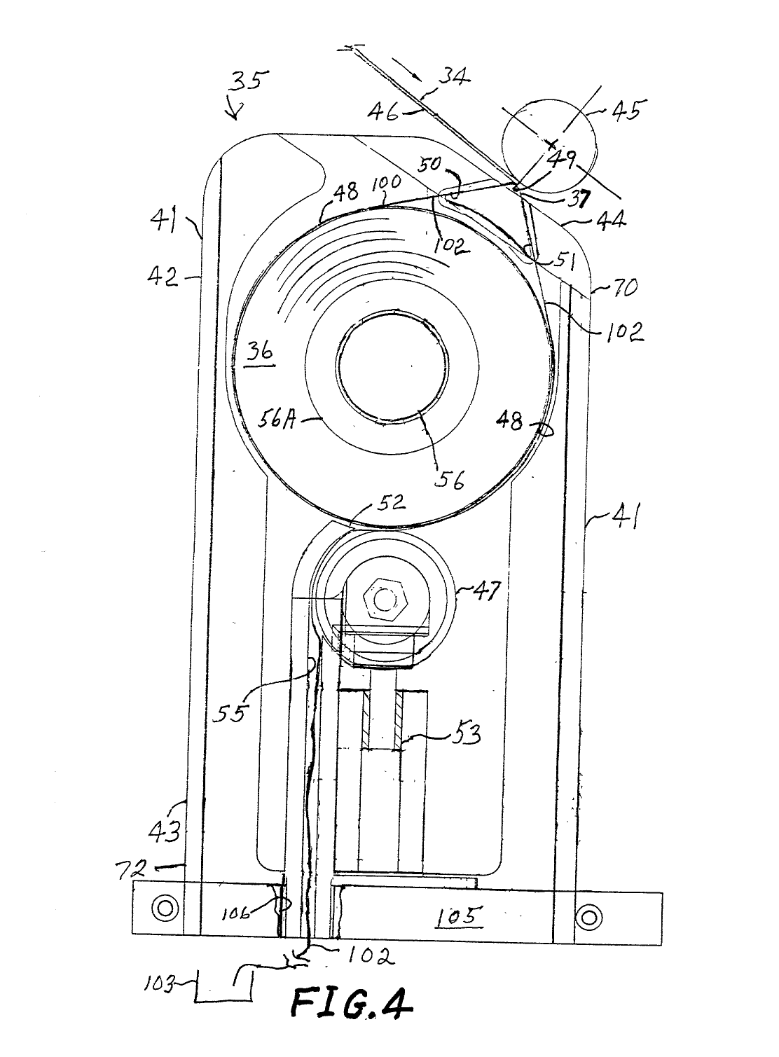

FIG. 3A shows strips 48 spaced along a release liner 102 and rolled to form supply roll 36 shown in FIG. 4. Strips 48 preferably are paper labels or of other material having strength characteristics as will be apparent from the further description of the invention. As FIG. 3B depicts, each strip 48 has an exposed face side 100 and unexposed back side 101 and each side is covered with a pressure sensitive adhesive 104. The back side 101 adheres to a strippable release liner 102, which has a release coating 103 on each face. The strip 48 is about ⅜ inch wide and 4 to 6 inches long and will be centered on about a ½ inch wide release liner 102. Silicon or the like coating 103 is applied to both sides of the release liner 102. There is also a space 48A between adjacent strips 48 of about ⅛ inch for insuring that only one strip 48 is applied to a cutting tape 34, as will be described more fully hereinafter. Further details may also be discerned from concurrently filed application entitled Roll of Adhesive Labels For Cutting Tape, Attorney Case No. D-7356, incorporated herein by reference thereto.

FIG. 4 shows the adhesive applicator 35 of the present invention in more detail and includes an elongated support or housing 41 having an upper portion 42 that includes a truncated portion 44 at a proximal end 70 of the housing 41 and a lower portion 43. A stationary nose member 37 is mounted on the truncated portion 44 and it is triangular in shape having two of its sides 50 and 51 joined at an apex to form a rounded tip 49 projecting outwardly of the housing 41. The nose member 37 is affixed to the housing 41 by rivets or the like. The housing 41 supports a stationary shaft 56 carrying a rotatable spindle 56A for receiving a supply roll 36 of layers of spaced strips 48 with exposed face sides 100 and unexposed back sides 101, each side having a pressure sensitive adhesive 104 thereon. The back side 101 is adhered to release liner 102, best shown in FIGS. 3A and 3B. The supply roll 36 is positioned generally medially of the upper portion 42 on the spindle 56 and adjacently below the stationary nose member 37. A press member, preferably a rotatable press roll 45 is positioned diametrically opposite and above the rounded tip 49 of the nose member 37. The press roll 45 is movable upwardly and downwardly and its movement is controlled by a solenoid or air cylinder 33A via a sensor 57, shown in FIG. 2, located above the housing 41 and adjacent the guideway extension of the track 40 in the apparatus 30. The sensor 57 calculates the travel time of the tape 34 of the distance between the sensor 57 and the rounded tip 49 of the nose member 37 and sends a signal to the solenoid or air cylinder 33A to move press roll 45 downwardly at the appropriate time. Alternatively, the timing function can be performed by the main driving roll 32.

When an operator decides it is time to apply an adhesive to the cutting tape 34, the operator presses a control button to send a signal to main driving roll 32 to forward the tape 34 through the guideway extension of track 40. The tape 34 passes adjacent the sensor 57 and the tape 34 travels until the cutting tape 34 passes adjacent the rounded tip 49 where the sensor 57 sends a signal to the solenoid or air cylinder 33A to move the press roll 45 downwardly in order to press the lower surface 46 of the cutting tape 34 into contact with the end portion of an exposed face side 100 of adhesive strip 48 to cause the exposed face side 100 to adhere to the lower surface 46 of cutting tape 34 and separate from the release liner 102 when the release liner 102 is pulled laterally along the side 51 of the stationary nose member 37. The spent release liner 102 becomes attached to the supply roll 36 by the rotatable movement of the supply roll 36, which is aided by a rotatable nip roll 47 spacedly positioned beneath the supply roll 36 which presses the spent release liner 102 onto the supply roll 36 to maintain the spent release liner 32 under tension all the time. Of course, the applicator 35 is set with the leader of the release liner 102 (i.e., a leading portion of the release liner without any strips 48 thereon) extending between the nose 49, attached to strips 48 on the downstream side of roll 36 and thence exposed face sides 100 of the strip 48 wrapped around the supply roll 36 while the nip roll 47 presses against the supply roll 36. The space between the doctor knife edge 52 and the nip roll 47 forms a waste channel 55 for receiving the spent release liner 102 and sending it to a waste zone 103, shown in FIG. 2. Channel 55 extends through the base 105 and out hole 106 formed in base 105 to assure disposal of spent release liner 102 away from adhesive applicator 35.

In order to assure the rotation of the supply roll 36 and to enable the doctor knife edge 52 to separate the spent release liner 102 from the exposed face sides 100 of the strip 48 as the thickness of the strip 48 decreases due to consumption of the strips 48 on the spent release liner 102, a means 53 for upwardly urging the nip roll 47 against the roll 36 and moving the nip roll 47 and the doctor knife edge 52 is positioned beneath them at a distal end 72 of the lower portion 43, and such means 53 may include a spring or an air cylinder lifting mechanism or the like.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

What is claimed as new and what it is desired to be secured by Letters Patent is:

1. An adhesive applicator for applying a strip of double-sided pressure sensitive adhesive to a surface of a cutting tape traveling through an elongated track, said applicator comprising a housing having an upper portion and a lower portion, a rotatable spindle for receiving a supply roll having layers of spaced strips with exposed face sides and unexposed back sides with each side having a pressure sensitive adhesive thereon and with back sides being adhered to an elongated continuous release liner, said spindle being positioned generally medially of said upper portion, a stationary nose member mounted to said housing and having a rounded tip exposed outwardly of said housing and being disposed at a proximal end of said upper portion of said housing above said spindle and any supply roll disposable thereon, a press member positioned diametrically opposite and above said rounded tip and being vertically movable downwardly to force an exposed face side of an adhesive strip on said rounded tip into contact with a lower surface of a generally horizontally incoming cutting tape to cause an exposed face side to adhere to a lower surface of a cutting tape and separate from a release liner when a release liner rotates around said tip.

2. The applicator of claim 1 further including a rotatable nip roll spacedly positioned beneath a supply roll for pressing spent release liner onto a supply roll, a doctor knife edge positioned spacedly and adjacent said nip roll and beneath said supply roll for separating spent release liner from exposed face sides of strips around a supply roll while said nip roll presses against a supply roll.

3. The applicator of claim 2 further including a waste channel formed in a space between said doctor knife edge and said nip roll for receiving spent release liner and sending it to a waste zone.

4. The applicator of claim 2 further including means for urging said doctor knife edge and said nip roll upwardly to press against spent release liner onto a supply roll to aid rotation of a supply roll and to enable said doctor knife edge to separate a spent release liner from exposed face sides of strips around a supply roll and to accommodate for the decrease in diameter of a supply roll due to dispensing of strips and spent release liner.

5. The applicator of claim 1 further including in combination a main driving roll of an apparatus for spoolig and cutting a web of paper for forwarding generally horizontally incoming cuttings tape.

6. The applicator of claim 1 further including in combination an optical sensor positioned in proximity with said stationary nose member for detecting presence or absence of adhesive on a lower surface of a generally horizontally exiting cutting tape, an upwardly movable abort block means positioned adjacent said track, and a control for receiving output signals from said sensor and sending a signal to said abort block means to move upwardly to divert a cutting tape having no adhesive strip on its lower surface.

7. The applicator of claim 1 wherein said press member is a rotatable press roll.

8. The applicator of claim 7 further including in combination an optical sensor for controlling the movement of said press roll downwardly to press into contact a lower surface of a cutting tape with an exposed face side of an adhesive strip.

9. In an apparatus for cutting a moving web of paper being wound on a spool and transferring that web onto an empty spool by attaching a cutting tape to an empty spool, said apparatus comprising an elongated fixed support extending behond side edges of a web, an elongated track having opposite open ends adjacent side edges of a web, a main driving roll for forwarding a cutting tape into an adjacent one said open and exiting out of another remote said open end, an adhesive applicator for applying a strip of double-sided pressure sensitive adhesive to a cutting tape lower surface before entering said one adjacent open end, said applicator including a housing having an upper portion and a lower portion, a rotatable supply roll having layers of spaced strips with exposed face sides and unexposed back sides with each side having a pressure sensitive adhesive thereon and back sides being adhered to an elongated continuous release liner, said supply roll being positioned generally medially of said upper portion and, a stationary nose member mounted to said housing and having a rounded tip exposed outwardly of said housing and being disposed at a proximal end of said upper portion of said housing above said supply roll, press member positioned diametrically opposite and above said rounded tip and being vertically movable downwardly to force an exposed face side of an adhesive strip on said rounded tip into contact with a lower surface of a generally horizontally incoming cutting tape to cause an exposed face side to adhere to a lower surface of a cutting tape and separate from a release liner when a release liner rotates around said tip.

10. In the apparatus of claim 9 further including a rotatable nip roll spacedly positioned beneath said supply roll for pressing spent release liner onto said supply roll, a doctor knife edge positioned spacedly and adjacent said nip roll and beneath said supply roll for separating spent release liner from exposed face sides of strips around said supply roll while said nip roll presses against said supply roll.

11. In the apparatus of claim 9 further including an optical sensor mechanism positioned outside said housing in proximity with and upstream from said nose member and adjacent said track for detecting movement of an incoming cutting tape and signaling said press member to move downwardly to press a lower surface of incoming cutting tape into contact with an exposed face side of an adhesive strip.

12. In the apparatus of claim 9 further including an optical sensor mechanism positioned in proximity with and downstream from said stationary nose member for detecting presence or absence of adhesive on a lower surface of a generally horizontally exiting cutting tape and for aborting an exiting cutting tape when said sensor detects absence of adhesive strip.

13. In the apparatus of claim 9 further including a brake section mounted on said track spacedly downstream of said sensor for frictionally engaging a cutting tape to assist in controlling its releasing movement from said track.

14. In the apparatus of claim 9 further including a curved section positioned at said another remote open end of said track having a configuration for receiving a cutting tape from said brake section and inverting it to position a pressure sensitive adhesive on a lower surface of a cutting tape upwardly and to be fed to a nip formed between an empty spool and a web driving spool, and said curved section having a supporting member for said section.

15. The applicator of claim 9 wherein said press member is a rotatable press roll.

16. In the apparatus of claim 9 wherein said applicator further includes a waste channel formed in a space between said doctor knife edge and said nip roll for receiving spent release liner and sending it to a waste zone.

17. In the apparatus of claim 9 wherein said applicator further includes means for urging said doctor knife edge and said nip roll upwardly to press spent release liner onto said supply roll to enable said doctor knife edge to separate spent release liner from exposed face sides of strip around said supply roll.

18. An adhesive applicator for applying a strip of double-sided pressure sensitive adhesive to a cutting tape surface, said apparatus comprising a housing having an upper portion and a lower portion, a rotatable supply roll having layers of spaced strips with exposed face sides and unexposed back sides with each side having a pressure sensitive adhesive thereon, said back side being adhered to a release liner, said supply roll being positioned generally medially of said upper portion and, a stationary nose member mounted to said housing and having a rounded tip exposed outwardly of said housing and being disposed at a proximal end of said upper portion of said housing above said supply roll, press member positioned diametrically opposite and above said rounded tip and being vertically movable downwardly to force said exposed face side of said adhesive strip on said rounded tip into contact with a lower surface of a generally horizontally incoming cutting tape to cause said exposed face side to adhere to a lower surface of cutting tape and separate from a release liner when a release liner rotates around said tip.

19. The applicator of claim 18 further including a rotatable nip roll spacedly positioned beneath said supply roll for pressing spent release liner onto said supply roll, a doctor knife edge positioned spacedly and adjacent said nip roll and beneath said supply roll for separating spent release liner from said exposed face sides of said strip around said supply roll while said nip roll presses against said supply roll.

20. The applicator of claim 19 further including means for urging said doctor knife edge and said nip roll upwardly to pres spent release liner onto said supply roll to aid rotation of said supply roll and to enable said doctor knife edge to separate spent release liner from said exposed face sides of said strip around said supply roll.

21. The applicator of claim 19 further including a waste channel formed in a space between said doctor knife edge and said nip roll for receiving spent release liner and sending it to a waste zone.

22. The applicator of claim 18 further including in combination an optical sensor positioned in proximity with and downstream from said stationary nose member for detecting presence or absence of adhesive on a lower surface of a generally horizontally exiting cutting tape, an upwardly movable abort block means positioned adjacent said track, and a control for receiving output signals from said sensor and sending a signal to said abort block means to move upwardly to divert a cutting tape having no adhesive strip on its lower surface.

23. The applicator of claim 18 wherein said press member is a rotatable press roll.

24. A method for applying a strip of double-sided pressure sensitive adhesive to a cutting tape surface, said method comprising the steps of:
A. rotating layers of spaced strips with exposed face sides and unexposed back sides with each side having a pressure sensitive adhesive thereon, the back side being adhered to a release liner, around a rounded tip of a stationary nose member;
B. pressing a lower surface of a generally horizontally incoming cutting tape into contact with the exposed face side of the adhesive strip on a rounded tip into contact to cause adherence to-the lower surface of the cutting tape and separation from the release liner when the release liner sufficiently moves around the tip;
C. pushing the cutting tape in a generally horizontal direction to force a substantial portion of a facing side of the strip to adhere to the cutting tape;
D. ceasing step B; and
E. pushing the cutting tape in a generally horizontal direction to force the remainder of the face side of the strip to adhere to the cutting tape while advancing the spent release liner.

25. The method of claim 24 further including the steps of:
F. pressing the spent release liner onto the supply roll to tension release liner around nose member providing a definitive path for the spent release liner;
G. separating the spent release liner from the exposed face sides of the strips around the supply roll;
H. urging a nip roll against the supply roll to maintain the spent release liner in contact with the supply roll; and
I. guiding the spent release liner into a waste zone.

26. The method of claim 24 wherein step B includes the step of:
F. downwardly moving a pressing roll to force the lower surface of the generally horizontally incoming cutting tape into contact with the exposed face side of the adhesive strip on the rounded tip.

27. The method of claim 25 wherein step F includes the step of:
J. upwardly moving a nip roll to press against the supply roll to assure rotation of the supply roll by movement of the spent release liner.

28. The method of claim 25 wherein Step G includes the step of:
K. peeling the release liner from the exposed face sides of the strips around the supply roll by a doctor knife edge.

29. The method of claim 25 further including the step of:
N. urging the doctor knife edge and the nip roll upwardly to press the spent release liner by the nip roll onto the supply roll to enable the doctor knife edge closely spaced to the supply roll to separate the spent release liner from the exposed face sides of the strips around the supply roll.

30. The method of claim 24 further comprising the step of:
F. tensioning the spent release liner as it is moving about the nose member to separate the strip moving with the cutting tape from the spent release liner.
